(19) United States
(12) Patent Application Publication
(10) Pub. No.: US 2025/0259356 A1
(43) Pub. Date: Aug. 14, 2025

(54) METHOD FOR GENERATING IMAGE COLLECTION, ELECTRONIC DEVICE, AND COMPUTER STORAGE MEDIUM

(71) Applicants: Beijing Zitiao Network Technology Co., Ltd., Beijing (CN); Lemon Inc., Grand Cayman (KY)

(72) Inventors: Sheng Yuan, Beijing (CN); Linlin Chen, CULVER CITY, CA (US); Yixuan Wang, CULVER CITY, CA (US)

(21) Appl. No.: 19/048,779

(22) Filed: Feb. 7, 2025

(30) Foreign Application Priority Data
Feb. 8, 2024 (CN) 202410178209.0

(51) Int. Cl. G06T 11/60; G06F 3/0484

(52) U.S. Cl. CPC G06T 11/60; G06F 3/0484; G06T 2200/24

(57) ABSTRACT

Embodiments of the present disclosure provide a method for generating an image collection. The method includes: displaying an image preview page in response to a trigger instruction associated with a first image collection, and at least part of text materials included in the image collection template is displayed in a specified region of the image preview page; displaying at least one image in the specified region in response to acquiring the at least one image, where the at least part of the text materials are overlaid on a corresponding one of the at least one image; and generating a second image collection based on the at least one image and the at least part of the text materials.

### CROSS-REFERENCE TO RELATED APPLICATION(S)

This application claims priority to Chinese Application No. 202410178209.0 filed Feb. 8, 2024, the disclosure of which is incorporated herein by reference in its entirety.

### FIELD

The present disclosure generally relates to the field of computers, and more particularly, to a method for generating an image collection, an electronic device, and a computer storage medium.

### BACKGROUND

With the continuous development of terminal devices and Internet technologies, a variety of client applications constantly emerge. Users can browse, through multimedia applications, various types of multimedia segments (for example, image collections) posted by creators. When browsing various types of multimedia segments, a user is usually inspired by the creators and wants to share life, express attitudes, and tell stories by creating their own image collections. Therefore, it is desired to provide an effective template-based creation mode, which allows a user to quickly and easily share their own stories under the inspiration of image collections posted by creators, thereby further reducing the system operation time and improving the efficiency in content generation.

### SUMMARY

According to a first aspect of the present disclosure, there is provided a method for generating an image collection. The method includes: displaying an image preview page in response to a trigger instruction associated with a first image collection, where the first image collection is associated with an image collection template, and at least part of text materials included in the image collection template is displayed in a specified region of the image preview page; displaying at least one image in the specified region in response to acquiring the at least one image, where the at least part of the text materials are overlaid on a corresponding image of the at least one image; and generating a second image collection based on the at least one image and the at least part of the text materials.

According to a second aspect of the present disclosure, there is provided a method for processing an image collection. The method includes: sending an image collection template associated with a first image collection to a user device in response to calling of the image collection template by the user device, where at least part of text materials included in the image collection template is displayed in a specified region of an image preview page of the user device; receiving a second image collection generated with the image collection template, where the second image collection is generated by overlaying the at least part of the text materials on a corresponding image of at least one image; and posting the second image collection, where the second image collection includes the at least part of the text material.

According to a third aspect of the present disclosure, there is provided an electronic device, including: at least one processing unit; and at least one memory coupled to the at least one processing unit and storing instructions executable by the at least one processing unit, where the instructions, when executed by the at least one processing unit, cause the electronic device to perform the method as described in the first aspect or the second aspect of the present disclosure.

According to a fourth aspect of the present disclosure, there is provided a computer-readable storage medium having machine-executable instructions stored thereon, where the machine-executable instructions, when executed by a device, cause the device to perform the method as described in the first aspect or the second aspect of the present disclosure.

According to a fifth aspect of the present disclosure, there is provided a computer program product including computer-executable instructions, where the computer-executable instructions, when executed by a processor, cause the processor to perform the method as described in the first aspect or the second aspect of the present disclosure.

The Summary section is provided to describe a series of concepts in a simplified form, which will be further described in the detailed description below. The Summary section is neither intended to identify critical or essential features of the present disclosure, nor is it intended to limit the scope of the present disclosure. Other features of the present disclosure will be readily understood from the following description.

### BRIEF DESCRIPTION OF THE DRAWINGS

The foregoing and other features, advantages, and aspects of embodiments of the present disclosure become more apparent with reference to the following detailed description and in conjunction with the accompanying drawings. In the accompanying drawings, the same or similar reference numerals denote the same or similar elements.

FIG. 1 is a schematic diagram of an example system in which the embodiments of the present disclosure can be implemented;

FIG. 2 is a flowchart of a method for generating an image collection according to an embodiment of the present disclosure;

FIG. 3A to FIG. 3C are schematic diagrams of displaying at least one reference image in a first image collection according to an embodiment of the present disclosure;

FIG. 4 is a schematic diagram of an image preview page according to some embodiments of the present disclosure;

FIG. 5A to FIG. 5H are schematic diagrams of a process for generating a second image collection according to an embodiment of the present disclosure;

FIG. 6A and FIG. 6B are schematic diagrams of image preview pages according to some other embodiments of the present disclosure;

FIG. 7 is a flowchart of a method for processing an image collection according to some embodiments of the present disclosure;

FIG. 8 is a schematic block diagram of an example apparatus according to some embodiments of the present disclosure;

FIG. 9 is a schematic block diagram of an example apparatus according to some embodiments of the present disclosure; and

FIG. 10 is a block diagram of an example device that can be used to implement the embodiments of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

Currently, users can browse, through multimedia applications, various types of multimedia segments, such as image collections, posted by creators. When browsing various types of image collections, a user is usually inspired by the creators and wants to share life, express attitudes, and tell stories by creating their own image collections. However, there are a variety of inconvenient operations in current template-based creation modes, which results in a poor user experience during template-based creation. Therefore, it is desired to provide an effective template-based creation mode, which allows a user to quickly and easily share their own stories under the inspiration of image collections posted by creators, thereby further reducing the system operation time and improving the efficiency in content generation.

In view of this, an embodiment of the present disclosure provides a method for generating an image collection. The method includes: displaying an image preview page in response to a trigger instruction associated with a first image collection, wherein the first image collection is associated with an image collection template, and at least part of text materials included in the image collection template is displayed in a specified region of the image preview page; displaying at least one image in the specified region in response to acquiring the at least one image, where the at least part of the text materials are overlaid on a corresponding image of the at least one image; and generating a second image collection based on the at least one image and the at least part of the text materials. According to the method for generating an image collection according to the embodiment of the present disclosure, a user can be provided with a more convenient and effective template-based creation mode, which allows the user to quickly and easily share their own stories under the inspiration of image collections posted by creators, thereby further reducing the system operation time and improving the efficiency in content generation.

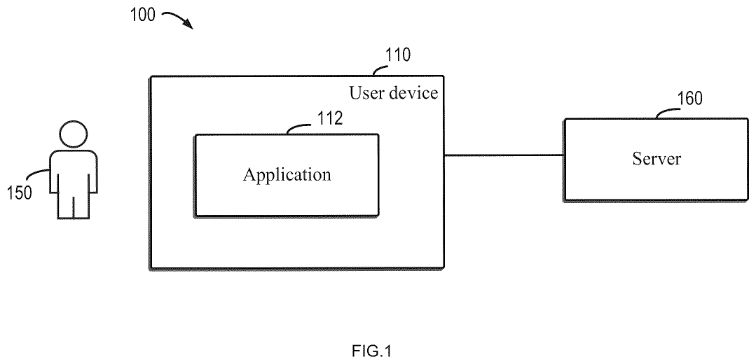

FIG. 1 is a schematic diagram of an example system 100 in which the embodiments of the present disclosure can be implemented. The example system 100 includes a user device 110, and an application 112 is installed on the user device 110. A user 150 may interact with the application 112 via the user device 110 and/or a device attached to the user device 110. In some embodiments, the application 112 may include, but is not limited to, a multimedia application, and may provide the user 150 with various services related to multimedia content items, including but not limited to browsing, creation, etc. of multimedia content.

In some embodiments, the user device 110 may include, but is not limited to, a personal computer, a server computer, a handheld or laptop device, a mobile device (such as a mobile phone, a personal digital assistant (PDA), or a media player), a multiprocessor system, a consumer electronic product, a wearable electronic device, a smart home device, and a combination of any system or device of the above systems or devices. In some embodiments, as shown in the system 100 in FIG. 1, the user device 110 may communicate with a server 160, so that the application 112 installed on the user device 110 is supported by the server 160. For example, the user 150 may distribute, via the server 160, a locally generated image collection to applications on a plurality of user devices that are equivalent to the application 112, thereby implementing a distribution operation for the image collection via the server. In some embodiments, the server 160 according to the embodiment of the present disclosure may be various types of computing systems/servers capable of providing computing capabilities, including, but not limited to, a mainframe computer, an edge computing node, a user device in a cloud environment, etc. The specific type of the server 160 is not limited in the present disclosure.

When browsing the multimedia content (for example, an image collection) through the application 112 on the user device 110, the user 150 is usually inspired by the image collection posted by an image collection creator, and also wants to share life, express attitudes, and tell stories by creating their own image collection. In view of this, there is provided a method for generating an image collection according to an embodiment of the present disclosure. The method may provide a user with an effective template-based creation mode, which allows the user to quickly and easily share their own stories under the inspiration of image collections posted by creators, thereby further reducing the system operation time and improving the efficiency in content generation.

The method for generating an image collection according to the embodiment of the present disclosure may include: displaying an image preview page in response to a trigger instruction associated with a first image collection, where the first image collection is associated with an image collection template, and at least part of text materials included in the image collection template is displayed in a specified region of the image preview page; displaying at least one image in the specified region in response to acquiring the at least one image, wherein the at least part of the text materials are overlaid on a corresponding image of the at least one image; and generating a second image collection based on the at least one image and the at least part of the text materials. With the method for generating an image collection according to the embodiment of the present disclosure, a user can be provided with a more convenient and effective template-based creation mode, which allows the user to quickly and easily share their own stories under the inspiration of image collections posted by creators, thereby further reducing the system operation time and improving the efficiency in content generation.

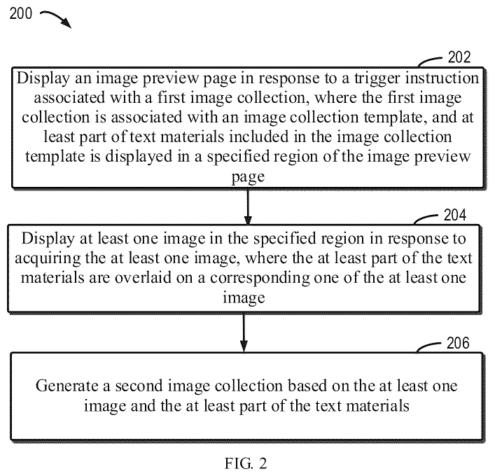

A block diagram of the example system 100 in which the embodiments of the present disclosure can be implemented has been described above with reference to FIG. 1. A flowchart of a method 200 for generating an image collection according to an embodiment of the present disclosure is described below with reference to FIG. 2. The method 200 may be performed at the user device 110 in FIG. 1 or at any appropriate user device.

At a block 202, the user device 110 displays an image preview page in response to a trigger instruction associated with a first image collection, wherein the first image collection is associated with an image collection template M, and at least part of text materials included in the image collection template M is displayed in a specified region of the image preview page.

In some embodiments, the first image collection may include an image collection that is created and uploaded to a server (for example, the server 160) by a creator. The server 160 may distribute the first image collection to the user device 110. The first image collection may include at least one reference image. When the first image collection includes a plurality of reference images, the user device 110 may display the plurality of reference images in a carousel manner. In addition, the first image collection may include an image collection created by the creator without using any previous template, or may include an image collection generated by the creator using a previous image collection template (for example, the existing image collection template M), which is not limited in the present disclosure.

In some embodiments, reference text may be overlaid (for example, in a superimposed manner) on a corresponding image of the at least one reference image in the first image collection. Reference text displayed on all reference images in the first image collection may be collectively referred to as text materials of the first image collection. Accordingly, reference text displayed on one reference image is at least part of the text material. In addition, an audio material may be added to the first image collection, so that audio may be played during the display of the first image collection. In addition, a sticker material and/or a filter material may further be added to the first image collection. Therefore, the first image collection may include the at least one reference image and the text material, and may further include one or more of the audio material, the sticker material, or the filter material.

In some embodiments, after receiving the first image collection uploaded by the creator, the server 160 may add a template identifier to the first image collection. In some embodiments, the server 160 may add the template identifier to the first image collection in response to the first image collection meeting a preset condition. In some embodiments, the preset condition may include, but is not limited to: the creator having selected an option for generating an image collection template when the first image collection is created; an evaluation parameter (for example, the number of evaluations, a positive rating, etc.) for the first image collection being greater than a first threshold; content of the first image collection being associated with target content; an attribute of the first image collection matching a preset attribute, and the attribute may include, but is not limited to: resolution of the reference image in the first image collection, etc.; or the text material in the first image collection being shared by more than a predetermined number of other image collections that are generated later than the first image collection, etc.

In some embodiments, the template identifier is added to the first image collection by the server 160, which may indicate that the first image collection is associated with the image collection template M. In some embodiments, the server 160 may generate the image collection template M associated with the first image collection when the first image collection meets the above preset condition. In some embodiments, the server 160 may extract information of the reference text included in the first image collection, and generate the image collection template M based on the extracted information. The text material included in the image collection template M corresponds to the reference text in the first image collection.

In some embodiments, as described above, the image collection template M includes the number of images required for generating an associated image collection and an associated text material. The number of images required may be equal to the number of reference images included in the first image collection. The text material may be a combination of text materials (for example, the pieces of reference text) overlaid on the reference images in the first image collection. In addition, the text material may include associated information, such as content, a language, a font, a position, etc. of text in the text material. The image collection template M is associated with the first image collection, and the template identifier corresponds to the image collection template M.

In some embodiments, an associated material of the image collection template M associated with the first image collection may further include one or more of the filter material, the sticker material, the audio material, etc. The filter material may be a combination of filters used in the corresponding reference image in the first image collection. Accordingly, information of the filter material may include a type of a filter, the reference image to which the filter is applied, etc. Similarly, the sticker material may be a combination of stickers used in the corresponding reference image in the first image collection. Accordingly, information of the sticker material may include a type of a sticker, the reference image to which the sticker is applied, etc. Similarly, the audio material may be audio used in the first image collection. Accordingly, information of the audio material may include a name, playback rate, playback start point of the audio, etc.

In some embodiments, when the user 150 is inspired by the first image collection when viewing the first image collection and also wants to create an image collection, the user may trigger the template identifier in a graphical user interface of the user device 110 that is associated with the first image collection. Accordingly, the user device 110 may display the image preview page in response to the trigger instruction associated with the first image collection. The image preview page may be used for preview of an image, and the image preview page may include the specified region. In some embodiments, a corresponding display box of at least one display box may be displayed in the specified region, wherein the at least one display box respectively corresponds to at least one reference image in the first image collection. That is, the number of the at least one display box is equal to the number of images in the image collection template that are required for generating the associated image collection.

In some embodiments, as described above, the first image collection is associated with the image collection template M, and the image collection template M includes the number of images required for generating the associated image collection and the associated text material. The text material may include one or more pieces of text material, wherein each piece of text material in the image collection template M may correspond to reference text that is overlaid on a corresponding reference image in the first image collection.

For example, when the server 160 generates the image collection template based on the first image collection, each piece of text material in the image collection template M may correspond to the reference text that is overlaid on a corresponding reference image in the first image collection. When the first image collection is generated based on the existing image collection template M, the reference text in the first image collection is set on the corresponding reference image in the first image collection based on attribute information of the text material in the image collection template. Accordingly, each piece of text material in the image collection template M corresponds to the reference text that is overlaid on a corresponding reference image in the first image collection.

The user device 110 may display a required number of display boxes in the specified region, to display images to be processed that are determined by the user for generating a second image collection. The display boxes may correspond to the reference images in the first image collection. For example, a first display box corresponds to a first reference image in the first image collection, a second display box corresponds to a second reference image in the first image collection, and so on. In other words, the required number is equal to the number of reference images in the first image collection.

In some embodiments, each piece of text material of the text material may have corresponding information, for example, attribute information. The attribute information may include a first position of the piece of text material, a second position of the piece of text material, and configuration information for the piece of text material. The first position may correspond to a reference image in the first image collection on which the reference text corresponding to the piece of text material is located. The second position corresponds to position information of the reference text corresponding to the piece of text material in the reference image. The configuration information includes, but is not limited to, content, a font, a font size, a language, and other information of the piece of text material.

In some embodiments, the text material included in the image collection template M is displayed in the specified region of the image preview page. The user device 110 may display each corresponding piece of text material at a corresponding position in the specified region according to the information of each piece of text material included in the image collection template M. For example, the user device 110 may display each corresponding piece of text material at a corresponding position in the display box displayed in the specified region based on the information of each piece of text material included in the image collection template M. For example, for a piece of text material S, a first position in its corresponding information indicates that the piece of text material S is applied to the first reference image in the first image collection; the second position indicates that the coordinates of the piece of text material S in the first reference image relative to the center point of the first reference image are (x1, y1); and the configuration information indicates that the piece of text material S has content of “OK”, a font size of 11, and a language of English. The user device 110 may display the piece of text material Sat a corresponding display position in the display box corresponding to the first reference image in the specified region, and the coordinates of the display position relative to the center point of the display box are (x1, y1), which are the same as the coordinates of a display position of the piece of text material S in the first reference image relative to the center point of the first reference image. Moreover, the piece of text material S has display content of “OK” in the specified region, a font size of 11, and a language of English.

At a block 204, the user device 110 displays at least one image in the specified region in response to acquiring the at least one image, wherein the at least part of the text material is overlaid on a corresponding one of the at least one image.

In some embodiments, the user 150 may select one or more images from images stored in the user device 110. In addition, the user 150 may also select one or more images by capturing images instantly. The manner of determining the at least one image by the user 150 is not specifically limited in the present disclosure.

Based on the at least one image determined by the user, the user device 110 may display the determined at least one image in the specified region of the image preview page, and the at least part of the text material is overlaid on the corresponding one of the at least one image.

In some embodiments, the user may determine at least one image respectively for the at least one display box displayed in the specified region. The user device 110 may display the determined at least one image in the corresponding display box. The text material displayed in the corresponding display box is overlaid on the determined corresponding image. Because the displayed display box corresponds to the corresponding reference image in the first image collection, the text material displayed in the corresponding display box corresponds to the reference text overlaid on the corresponding reference image.

For example, the piece of text material S described above is still used as an example for description. The piece of text material S is displayed at the corresponding display position in the display box corresponding to the first reference image in the specified region, and has display content of “OK”, a font size of 11, and a language of English. When the user determines an image Image 1 for the display box, the image Image 1 is displayed in the display box. Accordingly, the text material S is overlaid at a position P1 on the image Image 1 with content of “OK”, a font size of 11, and a language of English. The coordinates of the display position P1 relative to the center point of the image Image 1 are (x1, y1), which are the same as the coordinates of the display position of the piece of text material S in the first reference image relative to the center point of the first reference image.

At a block 206, the user device 110 may generate, in response to a generation operation, a second image collection based on the at least one image determined by the user and the text material.

In some embodiments, after determining the at least one image for generating an image collection (for example, the second image collection), the user 150 may determine to generate the second image collection by browsing through images displayed in the specified region of the image preview page. Accordingly, the user 150 may instruct the user device 110 to generate the second image collection by triggering an image collection generation control displayed on the page. The user device 110 may generate, in response to the generation operation, the second image collection based on the at least one image determined by the user and the text material (for example, the associated information of the text material) included in the image collection template. The user device 110 may generate the second image collection by combining the at least one image determined by the user with the information of the text material.

Advantageously, according to the method for generating an image collection according to the embodiment of the present disclosure, a user can be provided with a more convenient and effective template-based creation mode, which allows the user to quickly and easily share their own stories under the inspiration of image collections posted by creators, thereby further reducing the system operation time and improving the efficiency in content generation.

The process of generating the second image collection is described in detail below with reference to the accompanying drawings and the example first image collection. It may be understood that the following description made with reference to the accompanying drawings is merely illustrative, and does not constitute a limitation on the present disclosure. Those skilled in the art may make various modifications and adaptations to the method for generating an image collection in the embodiments of the present disclosure according to actual needs and application scenarios.

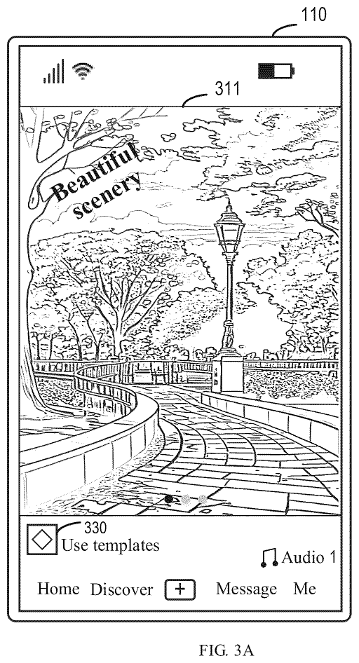

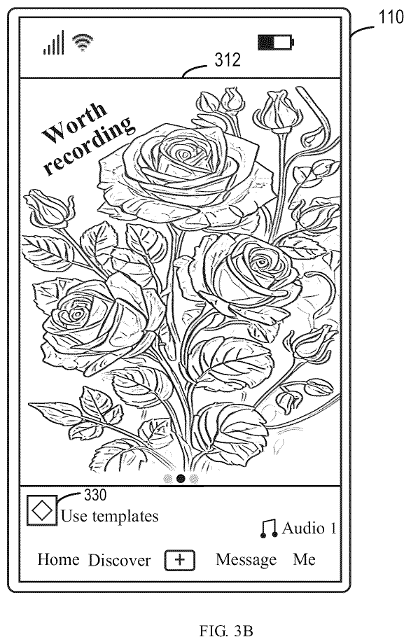

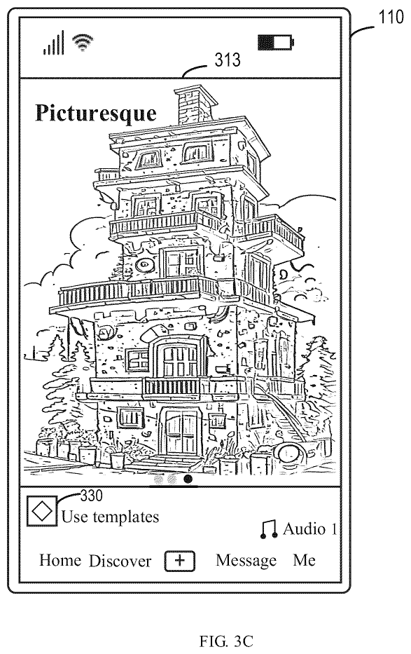

The first image collection including three reference images is used as an example for description. In addition, for the purpose of illustration, the first image collection may further include the audio material, for example, an audio segment named “Audio 1”. FIG. 3A to FIG. 3C are schematic diagrams of displaying reference images in a first image collection according to an embodiment of the present disclosure. In some embodiments, the first image collection may include an image collection created by a creator without using any previous template, or may include an image collection generated by the creator using a previous image collection template (for example, the existing image collection template), which is not limited in the present disclosure.

FIG. 3A is a schematic diagram of the user device 110 displaying a first reference image 311 in the first image collection in a graphical user interface. As shown in FIG. 3A, a template identifier 330 has been added to the first image collection by the server. Accordingly, during a process of the user device 110 displaying the first image collection, the template identifier of the first image collection is displayed in the graphical user interface of the user device 110, as shown by the template identifier 330, and a prompt may further be given by text “Use templates” in a region adjacent to the template identifier 330.

The audio material in the first image collection may further be played during the display of the first image collection, and the name of the audio material (for example, the “Audio 1” shown in FIG. 3A) is displayed in the graphical user interface of the user device 110, so as to be convenient for the user to know the currently playing audio material in the first image collection. As described above, the first image collection is associated with the image collection template M. Accordingly, the text material included in the image collection template M is also overlaid on the reference image in the first image collection. In other words, the reference text overlaid on the reference image in the first image collection is the text material included in the image collection template M. As shown in FIG. 3A, reference text, such as “Beautiful scenery”, is overlaid as a first text material on the first reference image 311. The displayed first text material is part of the text material in the image collection template M.

When the first image collection includes a plurality of reference images, the user device 110 may display or play the plurality of reference images in the first image collection in a carousel manner. When the user device 110 displays a second reference image in the carousel manner, as shown in FIG. 3B, the second reference image 312 is displayed in the graphical user interface. The audio material named “Audio 1” also continues playing as the plurality of reference images in the first image collection are displayed in the carousel manner, and an identifier of the audio material named “Audio 1” is also similarly displayed in the graphical user interface of the user device 110.

When the second reference image 312 is displayed, reference text may be overlaid as a second text material on the second reference image 312, for example, the reference text “Worth recording” may be overlaid on the second reference image 312 in FIG. 3B. The reference text may be part of the text material included in the image collection template M. It may be understood that although the first text material and the second text material have the same display position in the images in FIG. 3A and FIG. 3B, this is merely illustrative. During creation of an image collection, the creator can arbitrarily adjust the position and angle of the reference text in the corresponding reference image, that is, the two pieces of reference text do not necessarily have the same position and angle in the corresponding reference images.

Similarly, when a third reference image continues to be displayed, as shown in FIG. 3C, the third reference image 313 is displayed in the graphical user interface. The audio segment named “Audio 1” also continues playing as the reference image is displayed, and the identifier of the audio material named “Audio 1” is also similarly displayed in the graphical user interface of the user device 110.

As shown in FIG. 3C, reference text may be overlaid as a third text material on the third reference image 313, for example, the reference text “Picturesque” may be overlaid in FIG. 3C. The reference text may be part of the text material included in the image collection template M. It may be understood that during creation, the creator can arbitrarily adjust the position and angle of the reference text in the corresponding reference image, and different pieces of reference text do not necessarily have the same position and angle in the corresponding reference images. Moreover, the creator does not need to set reference text for each reference image.

Therefore, the first image collection shown in FIG. 3A to FIG. 3C is used as an example. An image collection template associated with the first image collection includes text materials and an audio material. Content information in associated information of the text material may include {Beautiful scenery, Worth recording, Picturesque}, and position information in the associated information of the text material includes: first position information {first reference image, second reference image, third reference image}, and second position information {position 1, position 2, position 1}. The above information indicates that a first piece of text material of the text material included in the image collection template M has content of “Beautiful scenery”, the piece of text material is applied to the first reference image, and the piece of text material has a position of position 1 relative to the center point in the first reference image. A second piece of text material of the text material included in the image collection template M has content of “Worth recording”, the piece of text material is applied to the second reference image, and the piece of text material has a position of position 2 relative to the center point in the second reference image. A third piece of text material of the text material included in the image collection template M has content of “Picturesque”, the piece of text material is applied to the third reference image, and the piece of text material has a position of position 3 relative to the center point in the third reference image. Information of the audio material included in the image collection template M may include: a name of “Audio 1” for the audio material, a cyclic playback mode, etc.

Those skilled in the art may understand that the first image collection shown in FIG. 3A to FIG. 3C is merely illustrative, and the number of reference images included in the first image collection, the information of the audio material and the reference text, etc. are not limited in the present disclosure.

In some embodiments, when the user 150 of the user device 110 is inspired by the first image collection when browsing through the first image collection, and also wants to use a material (such as the audio material and/or the text material) in the first image collection to create and generate an image collection, the user 150 can trigger the creation of the image collection by triggering the template identifier 330 associated with the first image collection.

The user can trigger the template identifier 330 when browsing any reference image in the first image collection. The user triggering the template identifier 330 when browsing to the third reference image 313 is used as an example for description. After the user performs a trigger operation on the template identifier 330, the user device 110 may display an image preview page in response to the trigger operation, and the image preview page may include a specified region.

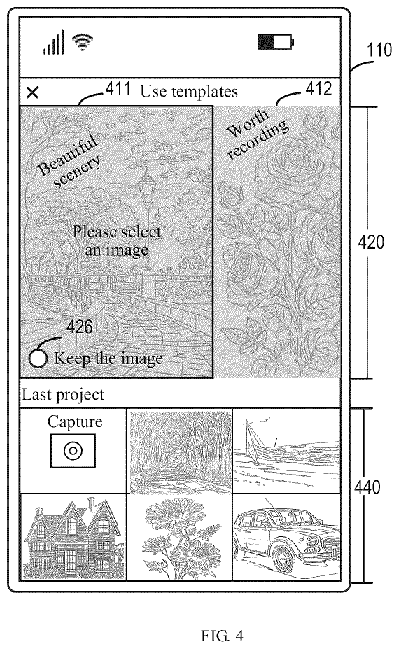

FIG. 4 is a schematic diagram of an image preview page according to some embodiments of the present disclosure. In some embodiments, as shown in FIG. 4, a user device 110 displays an image preview page in a graphical user interface in response to a trigger instruction 330. As shown in FIG. 4, the image preview page may be divided into two sub-pages: a sub-page 420 and a sub-page 440. The sub-page 420 may be a specified region for displaying a first display box among at least one display box, and displaying, in response to the user 150 having determined an image for generating a second image collection, the image that is determined by the user 150. The at least one display box respectively corresponds to the at least one reference image in the first image collection. The sub-page 440 is used for displaying at least one image to be selected and a capture entry (as shown in FIG. 4). The user 150 may select an image required for generating the second image collection by browsing through the image to be selected that is displayed on the sub-page 440. In addition, the user 150 may also capture a real-time image by tapping a capture control displayed on the sub-page 440 to enter a real-time capture page, and use the captured real-time image as the image for generating the second image collection.

In some embodiments, the user device 110 may display more images on the sub-page 440 in response to an operation of the user 150. In response to an up-to-down or left-to-right swipe operation of the user 150 in any region of the sub-page 440 of the user device 110, and based on a swipe direction in which the user 150 performs the swipe operation, the user device 110 may display to the user 150 more images as alternatives to images currently displayed on the sub-page 440. For example, when the user 150 performs the swipe operation in a bottom-to-up direction, the user device 110 may display more images as alternatives in the bottom-to-up direction. For example, images currently displayed in a first row are hidden from the sub-page 440, images currently displayed in a second row are displayed as alternatives in the first row, and new images are displayed in the second row of the sub-page 440. A method for updating the displayed image on the sub-page 440 is not limited in the present disclosure. Moreover, in addition to the swipe operation, the user 150 may display more images on the sub-page 440 through a voice trigger operation or other various appropriate trigger operations. In addition, more images may be displayed on the sub-page 440 by setting a control on the sub-page 440 or in another region. The specific manner of displaying images on the sub-page 440 is not limited in the present disclosure.

In some embodiments, the sub-page 420 is the specified region of the image preview page. The specified region may be used for displaying the first display box among the at least one display box, and the at least one display box may respectively correspond to the at least one reference image in the first image collection. The number of the at least one display box may be equal to the number of reference images in the first image collection. In other words, the number of the at least one display box may be equal to the number of images in the image collection template that are required for generating the associated image collection. For example, a display box 411 in FIG. 4 may correspond to the first reference image 311 in the first image collection. In some embodiments, a second display box among the at least one display box may also be at least partially displayed in the specified region 420, such as a display box 412 partially displayed in FIG. 4. It may be understood that the number and display manner of the display boxes displayed in the specified region 420 are not specifically limited in the present disclosure. For example, the user device 110 may at least fully display one display box in the specified region 420, to provide a preview for the user 150 during selection of an image.

In some embodiments, the at least one display box may respectively correspond to the at least one reference image in the first image collection. For example, a first display box 411 in FIG. 4 corresponds to the first reference image 311 in FIG. 3A, and a second display box 412 in FIG. 4 corresponds to the second reference image 312 in FIG. 3B. In addition, although not shown, it may be understood that the third reference image 313 in the first image collection may also correspond to a display box, and the display box is displayed during acquiring the image to be determined.

In some embodiments, the reference text on the corresponding reference image, i.e., at least part of the text material included in the image collection template M, may be displayed in the display box displayed in the specified region 420. The reference text on the corresponding reference image may be displayed in the corresponding display box based on the information of the reference text (for example, the first position information, the second position information, and the configuration information).

In particular, in response to first reference text being displayed on the first reference image corresponding to the first display box, the user device 110 may display the first reference text in the first display box based on information of the first reference text, and a display position of the first reference text in the first display box relative to the center point of the first display box is the same as a display position of the first reference text on the first reference image relative to the center point of the first reference image. The display position of the first reference text in the first display box may include position coordinates and a set angle and direction of the first reference text in the first display box relative to the center point of the first display box. Similarly, the display position of the first reference text in the first reference image may include position coordinates and a set angle and direction of the first reference text on the first reference image relative to the center point of the first reference image.

For example, as shown in FIG. 4, the display box 411 may correspond to the first reference image 311 in the first image collection, and as shown in FIG. 3A, the first reference image 311 has the reference text “Beautiful scenery” as part of the text material. Accordingly, the user device 110 may display the reference text in the first display box 411 in the specified region 420, and a display position of the reference text in the first display box is the same as a display position of the reference text in the first reference image 311 in FIG. 3A, as shown in FIG. 4.

In some embodiments, the user device 110 may display, in a display box displayed in the specified region 420, a reference image corresponding to the display box, so as to provide a reference for the user 150 during creation of an image collection. In some embodiments, the user device 110 may display, in the display box displayed in the specified region 420, a masked reference image, so as to provide a reference for the user 150 without affecting the acquiring a selected image or an image to be captured by the user 150. As shown in FIG. 4, the masked first reference image 311 that corresponds to the display box 411 is displayed in the display box 411.

In addition, in some embodiments, the user device 110 may further at least partially display the second display box of the at least one display box in the specified region 420. Moreover, in response to second reference text (corresponding to a corresponding piece of text material in the image collection template M) being displayed in the second reference image corresponding to the second display box, the second reference text is displayed in the second display box, wherein a display position of the second reference text in the second display box is the same as a display position of the second reference text on the second reference image.

As shown in FIG. 4, in the specified region 420, in addition to fully displaying the display box 411, the user device 110 may partially display the display box 412. The masked second reference image (such as the second reference image 312 in FIG. 3B) that corresponds to the display box 412 may also be partially displayed in the display box 412. In response to the second reference text (such as the reference text “Worth recording” in FIG. 3B) being displayed on the second reference image, the user device 110 may display the reference text in the display box 412, and the display position of the reference text in the display box 412 is the same as the display position of the reference text in the second reference image 312, as shown in FIG. 4.

In some embodiments, in response to the first display box being selected, the user device 110 may fully display the selected first display box in the specified region 420. The user device 110 may display, in the first display box, a first image to be processed that is determined by the user 150 when the first display box is selected. In response to the second display box being selected, the user device 110 may fully display the selected second display box in the specified region 420. The user device 110 may display, in the second display box, a second image to be processed that is determined by the user 150 when the second display box is selected.

In some embodiments, the user 150 may select a desired display box through an operation (various types of trigger operations, such as a swipe operation and a voice operation) in the graphical user interface. In response to the select operation, the user device 110 may fully display the selected display box in a related region section of the specified region 420.

In some embodiments, the user device 110 may select a display box automatically. The second display box being adjacent to the first display box in the specified region is used as an example for description. After the user determines the first image to be processed when the first display box is selected, the first image to be processed may be displayed in the first display box. Then, the user device 110 automatically selects the second display box and fully displays the second display box in the specified region 420.

In some embodiments, when the first display box is selected, the user device 110 may further highlight an edge of the first display box in the graphical user interface, so as to provide the user 150 with a prompt that the first display box is selected. It may be understood that the user device 110 may prompt the user in another manner, which is not limited in the present disclosure.

In some embodiments, when displaying the image preview page in response to the trigger instruction, the user device 110 may display, by default, an initial state of the page, i.e., a default image preview page. On the default image preview page, the first display box 411 corresponding to the first reference image 311 in the first image collection may be displayed in the specified region, as shown in FIG. 4. The user 150 may view, such as by means of the swipe operation, another display box and text materials displayed in the display box on the default image preview page.

In some embodiments, the user 150 may select an image stored in the user device 110 on the image preview page shown in FIG. 4 or determine, through real-time capturing, an image for generating the second image collection. Each time the user determines an image, the user device 110 may display the determined image in a currently selected display box.

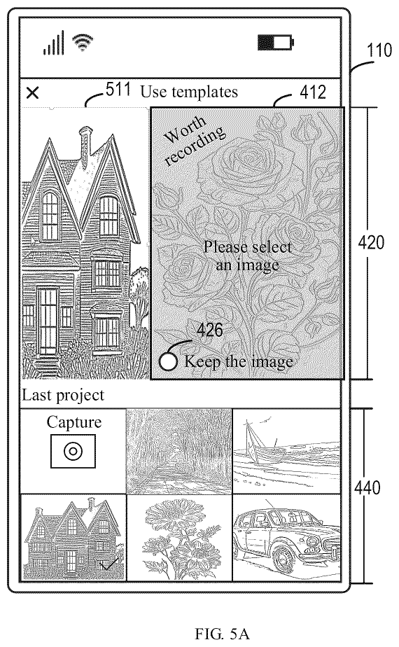

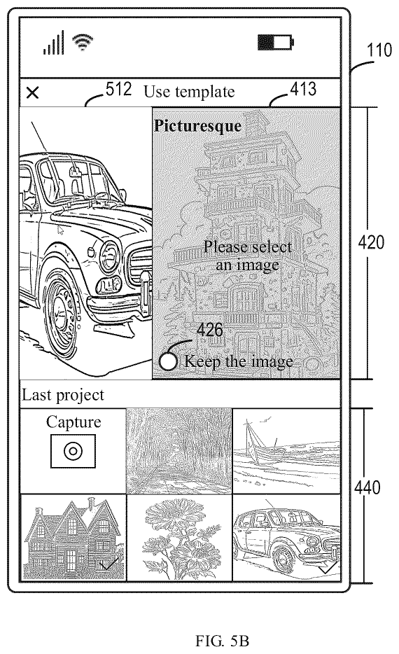

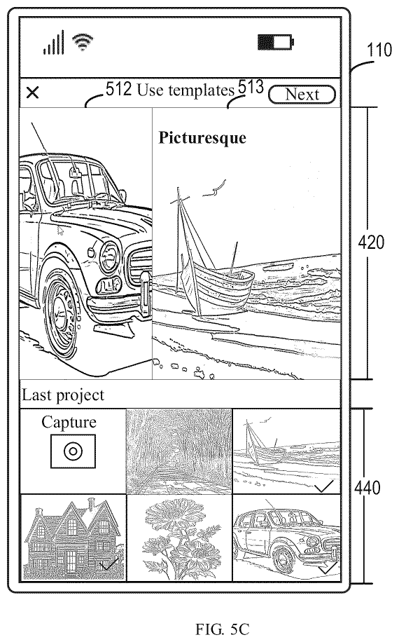

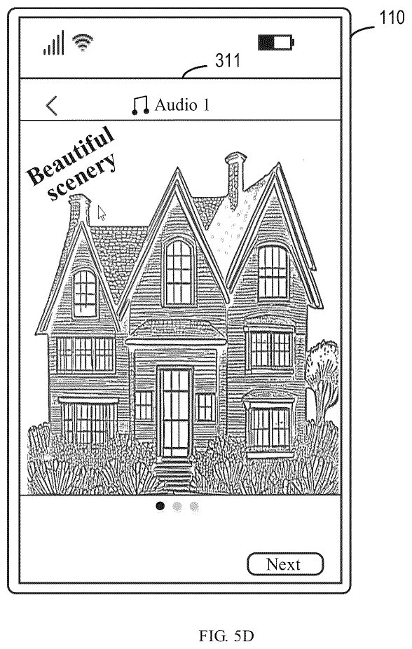

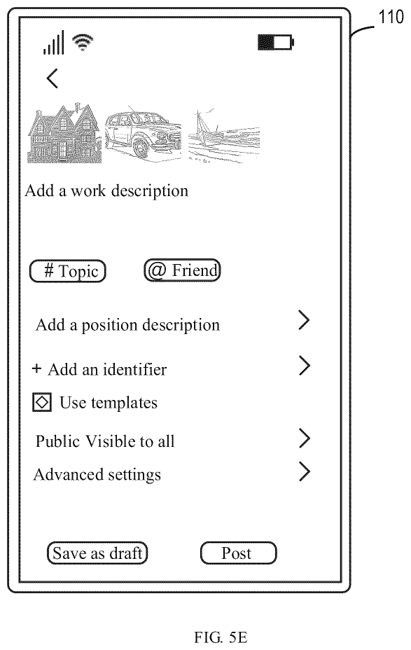

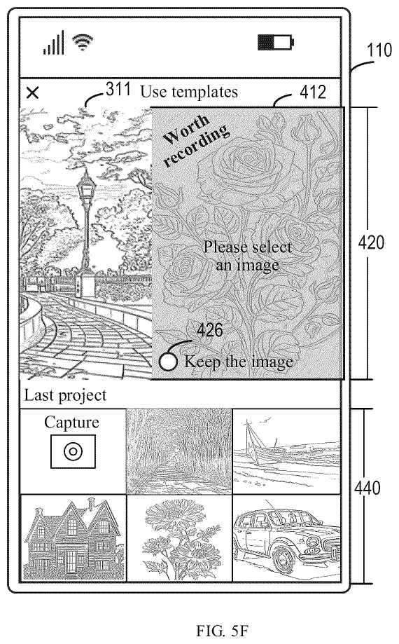

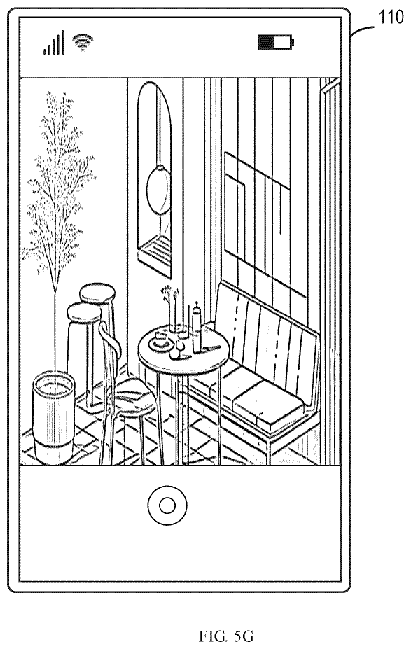

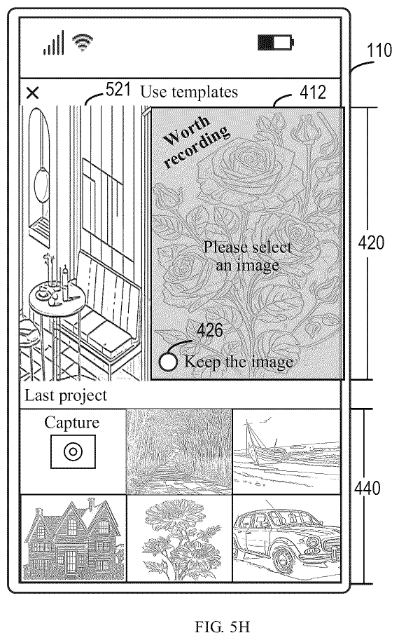

The image preview page shown in FIG. 4 is used as an example for description. As shown in FIG. 4, the currently selected display box is the display box 411, which corresponds to the first reference image in the first image collection, for example, corresponds to the reference image 311 in FIG. 3A. After the user 150 selects the first image from the left in the second row of the page of FIG. 4, the page is redirected to the page of FIG. 5A.

FIG. 5A to FIG. 5H are schematic diagrams of a process of generating a second image collection according to an embodiment of the present disclosure. In FIG. 5A, after the user 150 selects the first image from the left in the second row of the sub-page 440, the user device 110 may display the image in the display box 411 as an image 511 to be processed. Moreover, the user device 110 shifts the displayed image 511 to be processed to the left, and automatically selects, on the sub-page 420, the display box 412 adjacent to the display box 411. The user device 110 may fully display the display box 412 in the specified region 420, as shown in FIG. 5A.

Further, the user 150 may select or capture an image for the display box 412 on the page of FIG. 5A. The display box 412 may correspond to the second reference image in the first image collection, for example, correspond to the reference image 312 in FIG. 3B. If the user 150 selects the rightmost car image in the second row of the sub-page 440 in the current interface, the user device 110 may display the selected image in the display box 412 as an image 512 to be processed. Moreover, the user device 110 continues to shift the displayed image 512 to be processed to the left, automatically selects, on the sub-page 420, a display box 413 adjacent to the display box 412, and fully displays the display box 413 in the specified region 420, as shown in FIG. 5B.

In FIG. 5B, the selected display box is the display box 413. The display box 413 corresponds to the third reference image in the first image collection, for example, corresponds to the reference image 313 in FIG. 3C. The user 150 may continue to select or capture an image for the display box 413 on the page of FIG. 5B. If the user 150 selects the rightmost image in the first row of the sub-page 440 on the current page, the user device 110 may display the selected image in the display box 413 as an image 513 to be processed. Because there are totally three example display boxes in FIG. 4, that is, three images are required for generating the associated image collection based on the image collection template, the user 150 may accordingly select three images to be processed. After the user selects three images, the user device 110 may redirect the page to the page of FIG. 5C. In FIG. 5C, the display boxes are no longer displayed. Instead, at least some of the images determined by the user 150 for generating the second image collection are displayed, for example, the partially displayed second image 512 to be processed and the fully displayed third image 513 to be processed are displayed.

In some embodiments, when the corresponding image to be processed is displayed in the display box, the user device 110 may further overlay the reference text (corresponding to the text material in the image collection template) displayed in the corresponding display box on the image to be processed. Because the images 511 and 512 to be processed in FIG. 5A to FIG. 5C are partially displayed, and the pieces of reference text in the corresponding display boxes 411 and 412 are displayed at the upper left corners of the boxes, the corresponding pieces of reference text are not displayed when the images 511 and 512 to be processed are displayed in FIG. 5A to FIG. 5C. It may be understood that depending on the corresponding position of the reference text on the reference image (i.e., corresponding to the information of the text material in the image collection template), the user device 110 may accordingly adjust the position of the text on the image to be processed.

The page obtained after the user 150 determines all images for generating the second image collection is shown in FIG. 5C. Because the third image 513 to be processed may be fully displayed in the specified region, the user device 110 may display the third image 513 to be processed on which the reference text “Picturesque” on the third reference image 313 is superimposed, as shown in FIG. 5C. The reference text on the third reference image corresponds to the corresponding piece of text material in the image collection template.

In some embodiments, after determining that the user has determined all the images required for generating the second image collection, the user device 110 may provide a control for generating the second image collection on the page. The user 150 may trigger the generation operation by tapping the control (for example, a “Next” control shown in FIG. 5C), to enter an edit page. In other words, the user device 110 may generate the second image collection and display the edit page in response to the generation operation triggered by the user 150.

The edit page displayed by the user device 110 in response to the generation operation is shown in FIG. 5D. On the edit page, the user 150 may preview the second image collection. For example, when the second image collection includes a plurality of images, the user may preview the second image collection by manually switching the images. Alternatively, when the second image collection includes a plurality of images, the user device 110 may display the second image collection by displaying the plurality of images on the edit page in a carousel manner.

In some embodiments, the second image collection may be generated by the user device 110 based on the at least one image determined by the user and the information of the text material in the image collection template M (for example, the attribute information including the first position information, the second position information, and the configuration information). In some embodiments, the attribute information of each piece of text material in each image of the second image collection is the same as the attribute information of the piece of text material (for example, as the reference text) in the corresponding reference image in the first image collection. That is, the attribute information of the text material in the second image collection is the same as the attribute information of the text material in the image collection template M. In some embodiments, the attribute information of the audio material in the second image collection is the same as the attribute information of the audio material in the image collection template M.

In some embodiments, when displaying the images in the second image collection in the carousel manner, the user device 110 may display, in the carousel manner, the at least one image determined by the user for generating the second image collection, along with the audio material (for example, “Audio 1”) in the image collection template. Moreover, reference text is displayed on a corresponding one of the at least one image for generating the second image collection. The reference text is at least part of the text material in the image collection template, for example, it is a piece of text material, and corresponds to the reference text on the corresponding image in the first image collection. In some embodiments, based on the attribute information of each piece of text material in the image collection template, the user device 110 sets the piece of text material on the corresponding image of the second image collection for display. For example, based on first position information, second position information, and setting information of each piece of text material, the user device displays the piece of text material on the corresponding image in the second image collection.

In some embodiments, the user 150 may modify the reference text in the determined image on the page of FIG. 5D. For example, the user may initiate a modify operation for the reference text through a trigger operation (for example, by double-tapping the reference text overlaid on the image). Accordingly, the user device 110 may receive the modification made by the user in response to the modify operation for the text that is triggered by the user 150, adjust the reference text displayed in the current image based on the modification made by the user, and display the adjusted text. The user can modify the content of the text, position of the text, font of the text, size of the text, etc. The specific operation of modification made by the user 150 to the text is not limited in the present disclosure.

When the user 150 determines that the image on the page of FIG. 5D meets their requirements, the user may further enter a video post preparation page by triggering a control (for example, a “Next” operation control) on the page or in another manner, as shown in FIG. 5E.

In FIG. 5E, the user device 110 displays a preparation page for posting an image collection. The user 150 may set the second image collection on the page before the second image collection is posted, such as by adding a work description, adding a position description, setting a visibility range, and making other advanced settings. This is not specifically limited in the present disclosure.

In some embodiments, the user device 110 may add a template identifier to the second image collection in response to a user-triggered operation of adding a template identifier to the second image collection, where the template identifier is consistent with the template identifier 330 associated with the first image collection. Moreover, for the generated second image collection, the template identifier indicates that the second image collection is associated with the image collection template M. For example, in response to the user selecting the operation of adding a template identifier to the second image collection, the user device may associate the template identifier with the second image collection. After the second image collection is posted, another user who browses to the second image collection may similarly share the image collection template associated with the second image collection by triggering the template identifier, to generate a new image collection.

In addition, in some embodiments, as shown in FIG. 4 to FIG. 5B, on the image preview page, a prompt control 426 may further be included in the selected display box in the specified region. The prompt control 426 is used for prompting the user 150 of whether to use the masked reference image that is displayed in the display box as an image to be processed for generating the second image collection. In response to the triggering of the prompt control 426 by the user 150, the user device 110 may determine the corresponding reference image as the image to be processed, cancel the masking of the reference image, and display the reference image in a non-masked manner.

For example, the default image preview page in FIG. 4 is used as an example for description. When the user 150 triggers the prompt control 426, the user device 110 may determine, as the image to be processed for generating the second image collection, the first reference image 311 in the first image collection that corresponds to the display box 411, cancel the masking of the first reference image 311, and display the reference image 311 in the non-masked manner, as shown in FIG. 5F. FIG. 5F is similar to FIG. 5B, except that because the user 150 selects the reference image as the image to be processed in FIG. 5F, the first reference image 311 as shown in FIG. 3A is displayed in FIG. 5F. In addition, the user 150 may also select another reference image for another display box, and the user device 110 may perform similar operations. For the sake of brevity, details are not described herein again.

In some embodiments, in response to the triggering of the corresponding prompt control by the user, the user device 110 may send, via the server 160, request information to the creator of the first image collection, to confirm whether the user 150 is allowed to use the corresponding reference image as the image to be processed for generating the second image collection. After receiving authorization information from the creator of the first image collection, the user device 110 may determine the corresponding reference image as the corresponding image to be processed. If no authorization information has not been obtained from the creator of the first image collection for a predetermined period of time, or if information indicating authorization denied is received from the creator of the first image collection, the user device 110 may consider that the creator of the first image collection does not agree to use the reference image in the first image collection for generating the second image collection. Accordingly, the user device 110 may send to the user 150 prompt information indicating that the user 150 is not allowed to use the reference image in the first image collection for generating the second image collection.

In some embodiments, when the user 150 selects a capture control on the image preview page of FIG. 4, the user device 110 may guide the user to enter a capture interface, as shown in FIG. 5G. FIG. 5G shows a real-time capture interface. After the user 150 captures an image through the capture interface, the captured image may be displayed in the corresponding display box as the image to be processed. As shown in FIG. 5H, an image 521 captured by the user in FIG. 5G may be displayed in the corresponding display box 411, and the user device 110 automatically selects the display box 412 adjacent to the display box 411.

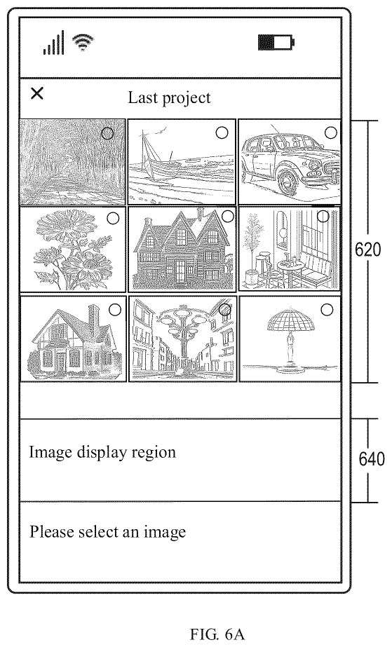

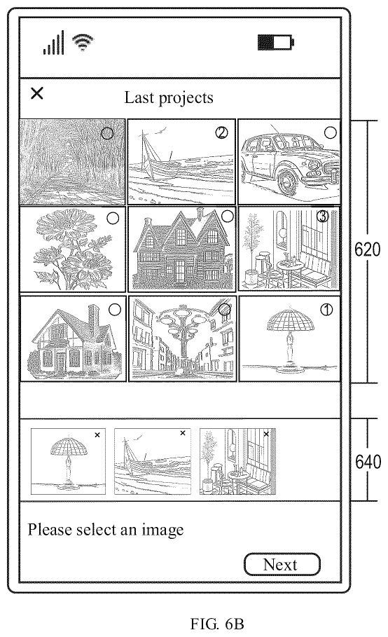

The schematic diagrams of the image preview page according to some embodiments of the present disclosure have been described above with reference to FIG. 4 to FIG. 5H. FIG. 6A and FIG. 6B are schematic diagrams of image preview pages according to some other embodiments of the present disclosure. In response to the trigger instruction associated with the first image collection, the user device 110 displays an image preview page as shown in FIG. 6A. The image preview page may also be divided into two sub-pages: a sub-page 620 and a sub-page 640. The sub-page 640 is used for displaying at least one image to be selected. Although not shown in FIG. 6A, those skilled in the art may understand that a capture entry for the user 150 to perform real-time capturing may further be included on the sub-page 620. The user 150 may select an image required for generating the second image collection by browsing through at least one image to be selected that is displayed on the sub-page 620. In addition, the user 150 may also capture a real-time image, and use the captured real-time image as the image for generating the second image collection. The sub-page 640 may be a specified region that displays at least one image that is determined by the user for generating the second image collection.

In some embodiments, a selection icon is displayed at the upper right corner of each image on the sub-page 620, for example, the selection icon is represented by a circle. The user 150 can select a corresponding image by tapping on the selection icon. Moreover, in some embodiments, according to a sequence in which images are selected by the user 150, the user device 110 may display a sequence number of a corresponding selected image on the corresponding selected image. After the user has made a selection on the page of FIG. 6A, the user device 110 may display a page obtained after the selection of the image is determined, as shown in FIG. 6B. On the page, according to a sequence in which images are selected by the user, the user device 110 may sequentially identify the selected images with numbers in selection icons of the selected images, as shown in FIG. 6B. Moreover, according to the sequence in which the images are selected by the user 150, the user device 110 sequentially displays, in the specified region of the sub-page 640, the images that are selected by the user 150. In some embodiments, the images displayed in the specified region of the sub-page 640 are displayed in the sequence in which they are selected by the user, and a cancel identifier may be overlaid on each image. The user 150 can cancel the selection for a corresponding image by tapping the cancel identifier on the image according to requirements, thereby implementing flexible and convenient image selection.

After the user 150 has determined the image for generating the second image collection, the user may enter an edit page by triggering a generation operation (for example, tapping a “Next” control on the page of FIG. 6B). In other words, the user device 110 may generate the second image collection and display the edit page in response to the generation operation triggered by the user 150.

In some embodiments, the edit page redirected to from the page of FIG. 6B may be the edit page of FIG. 5D. This may be understood with reference to the above description for FIG. 5D. For the sake of brevity, details are not described herein again. In addition, the user device 110 may further enter the post preparation page of FIG. 5E from the edit page of FIG. 5D as described above. Similarly, this may be understood with reference to the above description for FIG. 5E. Details are not described herein again.

In some embodiments, the text material in the image collection template associated with the first image collection may be automatically generated by a text generation model based on the at least one image in the first image collection during creation of the first image collection. For example, the server 160 may include a model for generating text materials, to generate the text material. Alternatively, the model may be set in a device other than the server 160, and the server 160 may call the model to generate the text material. The model may receive the at least one image in the first image collection, and generate reference text for the first image collection based on the at least one image. The generated reference text may be used as the text material in the image collection template associated with that first image collection. In some embodiments, the model may generate reference text for each reference image in the first image collection, and the reference text for each reference image may be combined together to form the text material in the first image collection. Accordingly, the reference text for each reference image may be combined together to be used as the text material in the image collection template associated with the first image collection.

Moreover, in some embodiments, the audio material in the first image collection may be selected and uploaded by the creator of the first image collection. In addition, the audio material in the first image collection may also be provided or generated by the model based on the at least one image in the first image collection. This is not limited in the present disclosure.

With the method for generating an image collection according to the embodiment of the present disclosure, a user can be provided with a more convenient and effective template-based creation mode, which allows the user to quickly and easily share their own stories under the inspiration of image collections posted by creators, thereby further reducing the system operation time and improving the efficiency in content generation.

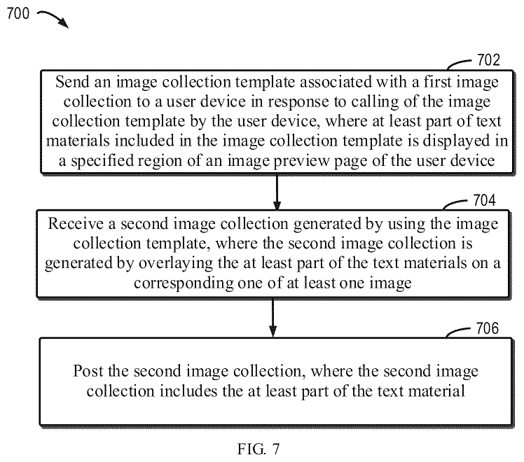

FIG. 7 is a flowchart of a method 700 for processing an image collection according to some embodiments of the present disclosure. The method 700 may be performed at the server 160 in FIG. 1 or at any appropriate server.

In a block 702, the server 160 may send an image collection template associated with a first image collection to the user device 110 in response to calling of the image collection template by the user device 110, and at least part of text materials included in the image collection template is displayed in a specified region of an image preview page of the user device 110.

The first image collection may include an image collection that is created and uploaded to the server 160 by a user. The first image collection may include at least one reference image. The first image collection may include an image collection created by a creator without using any previous template, or may include an image collection generated by the creator using a previous image collection template, which is not limited in the present disclosure.

In some embodiments, the user device 110 may display the image preview page in response to a trigger operation of the user, for example, a trigger instruction associated with the first image collection. Moreover, the trigger operation also indicates the calling of the image collection template by the user device 110. The server 160 may send the image collection template to the user device 110 in response to the calling of the image collection template by the user device 110. In some embodiments, the image collection template includes the number of images required for generating an associated image collection and an associated text material. The number of images required may be the same as the number of reference images in the first image collection. The text material in the image collection template corresponds to reference text in the first image collection.

In some embodiments, the user device 110 may display a required number of display boxes in the specified region, to display images to be processed that are determined by the user for generating a second image collection. The required number of display boxes corresponds to the number of images that are included in the image collection template and that are required for generating the associated image collection. In some embodiments, the display boxes may correspond to the reference images in the first image collection. For example, a first display box corresponds to a first reference image in the first image collection, a second display box corresponds to a second reference image in the first image collection, and so on. The user device 110 may display the text material included in the image collection template in the specified region of the image preview page of the user device 110. In some embodiments, the user device 110 may display a corresponding piece of text material in the display box in the specified region based on information of the text material. The specific display manner and implementation may be understood with reference to the description made in conjunction with FIG. 2. For the sake of brevity, details are not described herein again.

In some embodiments, when the first image collection includes an image collection created by a creator without using any previous template, the server 1620 may generate an associated image collection template for the first image collection. Specifically, the server 160 may receive the first image collection, and extract information of reference text included in the first image collection in response to the first image collection meeting a preset condition. The server 160 may generate the image collection template corresponding to the first image collection based on the extracted information of the reference text. In some embodiments, the text material included in the image collection template corresponds to the reference text in the first image collection. Accordingly, the information of the reference text in the first image collection may be used as information of the text material in the image collection template.

In some embodiments, the reference text may have corresponding information, for example, attribute information. The attribute information may include a first position of the reference text in a corresponding reference image in the first image collection, a second position of the reference text, and configuration information of the reference text. The first position indicates a reference image in the first image collection on which the reference text is located. The second position indicates a position, for example, coordinates, etc. of the reference text on the reference image. The configuration information includes, but is not limited to, content, a font, a font size, a language, and other information of the reference text.

In some embodiments, the preset condition may include, but is not limited to: the creator having selected an option for generating an image collection template when the first image collection is created; an evaluation parameter (for example, the number of evaluations, a positive rating, etc.) for the first image collection being greater than a first threshold; content of the first image collection being associated with target content; an attribute of the first image collection matching a preset attribute; or the text material in the first image collection being shared by more than a predetermined number of other image collections that are generated later than the first image collection, etc.

In addition, in some embodiments, the server 160 may further add a template identifier to the first image collection in response to the first image collection meeting the above preset condition, wherein the template identifier corresponds to the generated image collection template.

When the first image collection includes the image collection that is generated by the creator using the previous image collection template (for example, the existing image collection template), the server 160 may obtain the image collection template corresponding to the first image collection by querying an image collection template corresponding to the template identifier based on the template identifier of the first image collection. In addition, the server 160 may also generate the image collection template by extracting the information of the reference text in the first image collection in the above manner of generating the image collection template for the first image collection.

In addition, in some embodiments, the image collection template further includes at least one of the following: an audio material, a sticker material, or a filter material. The filter material may be a combination of filters used in the corresponding reference image in the first image collection. Accordingly, information of the filter material may include a type of a filter, the reference image to which the filter is applied, etc. Similarly, the sticker material may be a combination of stickers used in the corresponding reference image in the first image collection. Accordingly, information of the sticker material may include a type of a sticker, the reference image to which the sticker is applied, etc. Similarly, the audio material may be audio used in the first image collection. Accordingly, information of the audio material may include a name, playback rate, playback start point, etc. of the audio.

In a block 704, the server 160 may receive a second image collection generated with the image collection template, wherein the second image collection is generated by overlaying the at least part of the text material on a corresponding one of at least one image. In some embodiments, the server 160 may add a template identifier to the second image collection. For example, the server may add the template identifier to the second image collection in response to the second image collection meeting the above preset condition. This step may be understood with reference to the process of generating the second image collection described in FIG. 2 to FIG. 5H. For the sake of brevity, details are not described herein again.

In a block 710, the server 160 may post the second image collection, wherein the second image collection includes the at least part of the text material. For example, the server 160 may post the second image collection to a plurality of user devices for users to view.

In some embodiments, as described above, the server 160 may further generate reference text for the first image collection based on the at least one reference image in the first image collection with a text generation model. The model may be included in the server 160 or in a device other than the server 160. The model may receive the at least one image in the first image collection, and generate reference text for the first image collection based on the at least one image. The server 160 may generate the image collection template including text materials by extracting the information of the reference text in the first image collection based on the first image collection, where the text material corresponds to the reference text generated by the model.

The method in FIG. 7 may be understood with reference to the specific implementation described above in conjunction with FIG. 2 to FIG. 6B. For the sake of brevity, details are not described herein again.

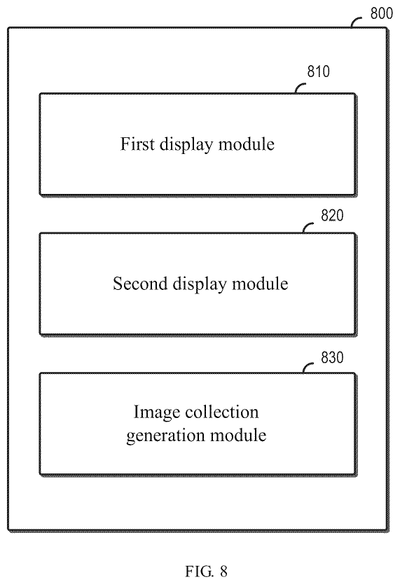

FIG. 8 is a schematic block diagram of an example apparatus 800 according to some embodiments of the present disclosure. The apparatus 800 may be implemented in the form of software, hardware, or a combination of software and hardware. As shown in FIG. 8, the apparatus 800 includes a first display module 810, a second display module 820, and an image collection generation module 830.

In some embodiments, the first display module 810 is configured to display an image preview page in response to a trigger instruction associated with a first image collection, where the first image collection is associated with an image collection template, and at least part of text materials included in the image collection template is displayed in a specified region of the image preview page. In some embodiments, the second display module 820 is configured to display at least one image in the specified region in response to acquiring the at least one image, where the at least part of the text materials are overlaid on a corresponding one of the at least one image. In some embodiments, the image collection generation module 830 is configured to generate a second image collection based on the at least one image and the at least part of the text materials.

The apparatus 800 in FIG. 8 can be used to implement the process described above in conjunction with FIG. 1 to FIG. 6B. For brevity, details are not described herein again. In addition, it may be understood that division into modules or units in the embodiments of the present disclosure is an example and is merely logical function division, and there may be another division manner during actual implementation. In addition, functional units in the embodiments of the present disclosure may be integrated into one unit, each of the units may exist alone physically, or two or more units may be integrated into one unit. The integrated unit may be implemented in the form of hardware, or may be implemented in the form of a software functional unit.

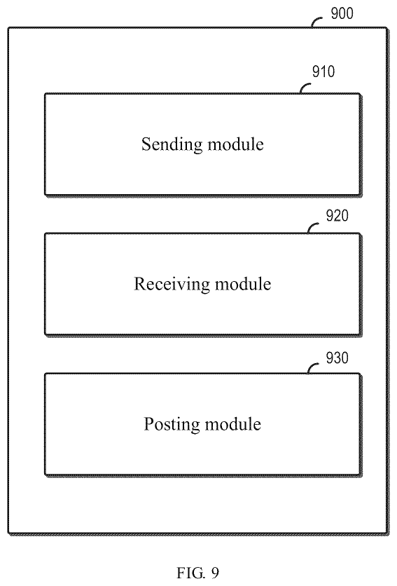

FIG. 9 is a schematic block diagram of an example apparatus 900 according to some embodiments of the present disclosure. The apparatus 900 may be implemented in the form of software, hardware, or a combination of software and hardware. As shown in FIG. 9, the apparatus 900 includes a sending module 910, a receiving module 920, and a posting module 930.

In some embodiments, the sending module 910 is configured to send an image collection template associated with a first image collection to a user device in response to calling of the image collection template by the user device, where at least part of text materials included in the image collection template is displayed in a specified region of an image preview page of the user device. In some embodiments, the second receiving module 920 is configured to receive a second image collection generated with the image collection template, where the second image collection is generated by overlaying the at least part of the text material on a corresponding one of at least one image. In some embodiments, the posting module 930 is configured to post the second image collection, where the second image collection includes the at least part of the text material.

The apparatus 900 in FIG. 9 can be used to implement the process described above in conjunction with FIG. 7. For brevity, details are not described herein again. In addition, it may be understood that division into modules or units in the embodiments of the present disclosure is an example and is merely logical function division, and there may be another division manner during actual implementation. In addition, functional units in the embodiments of the present disclosure may be integrated into one unit, each of the units may exist alone physically, or two or more units may be integrated into one unit. The integrated unit may be implemented in the form of hardware, or may be implemented in the form of a software functional unit.

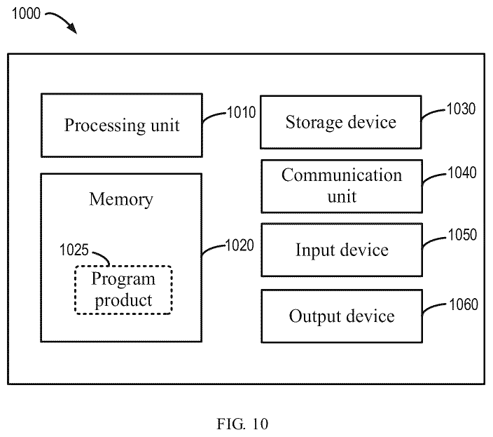

FIG. 10 is a block diagram of an example device 1000 that may be used to implement an embodiment of the present disclosure. It should be understood that the device 1000 shown in FIG. 10 is merely exemplary and should not constitute any limitation on the functions and scopes of the implementations described herein. For example, the device 1000 may be used to perform the process described above with reference to FIG. 1 to FIG. 6 or FIG. 7.

As shown in FIG. 10, the device 1000 is in the form of a general-purpose user device. Components of the user device 1000 may include, but are not limited to, one or more processors or processing units 1010, a memory 1020, a storage device 1030, one or more communication units 1040, one or more input devices 1050, and one or more output devices 1060. The processing unit 1010 may be a physical or virtual processor, and can perform various processing based on a program stored in the memory 1020. In a multi-processor system, a plurality of processing units execute computer-executable instructions in parallel, to improve a parallel processing capability of the user device 1000.

The user device 1000 generally includes a plurality of computer storage media. Such media may be any available media accessible by the user device 1000, including, but not limited to, volatile and non-volatile media and removable and non-removable media. The memory 1020 may be a volatile memory (for example, a register, a cache, or a random access memory (RAM)), a non-volatile memory (for example, a read only memory (ROM), an electrically erasable programmable read only memory (EEPROM), or a flash memory), or a certain combination thereof. The storage device 1030 may be a removable or non-removable medium, may include a machine-readable medium, for example, a flash drive, a disk, or any other medium, and may be configured to store information and/or data (for example, training data for training) and accessed in the user device 1000.

The user device 1000 may further include other removable/non-removable and volatile/non-volatile storage media. Although not shown in FIG. 10, a disk drive for reading from or writing into removable and non-volatile disks (for example, a “floppy disk”) and an optical disc drive for reading from or writing into removable and non-volatile optical discs may be provided. In these cases, each drive may be connected to a bus (not shown) through one or more data medium interfaces. The memory 1020 may include a computer program product 1025 having one or more program modules that are configured to perform various methods or actions in various implementations of the present disclosure.

The communication unit 1040 implements communication with another user device through a communication medium. In addition, functions of the components of the user device 1000 may be implemented by a single computing cluster or a plurality of computing machines, and these computing machines can communicate through a communication connection. Therefore, the user device 1000 may perform operations in a networked environment through a logical connection to one or more other servers, a network personal computer (PC), or another network node.

The input device 1050 may be one or more input devices, such as a mouse, a keyboard, and a trackball. The output device 1060 may be one or more output devices, such as a display, a speaker, and a printer. The user device 1000 may further communicate, through the communication unit 1040 as required, with one or more external devices (not shown), for example, a storage device and a display device, with one or more devices enabling a user to interact with the user device 1000, or with any device (for example, a network interface card or a modem) enabling the user device 1000 to communicate with one or more other user devices. Such communication may be performed through an input/output (I/O) interface (not shown).

According to an exemplary implementation of the present disclosure, there is provided a computer-readable storage medium having computer-executable instructions stored thereon. The computer-executable instructions are executed by a processor to implement the method as described above. According to an exemplary implementation of the present disclosure, there is further provided a computer program product. The computer program product is tangibly stored on a non-transitory computer-readable medium, and includes computer-executable instructions. The computer-executable instructions are executed by a processor to implement the method for generating an image collection or method for processing an image collection described above. According to an exemplary implementation of the present disclosure, there is provided a computer program product having a computer program stored thereon. The program, when executed by a processor, causes the method for generating an image collection or method for processing an image collection described above to be implemented.

Various aspects of the present disclosure are described here with reference to the flowcharts and/or the block diagrams of the method, the apparatus, the device, and the computer program product implemented according to the present disclosure. It should be understood that each block of the flowcharts and/or block diagrams and a combination of blocks in the flowcharts and/or block diagrams may be implemented by computer-readable program instructions.

These computer-readable program instructions may be provided to a processing unit of a general-purpose computer, a special-purpose computer, or another programmable data processing apparatus to produce a machine, such that the instructions, when executed by the processing unit of the computer or the another programmable data processing apparatus, create an apparatus for implementing functions/actions specified in one or more blocks in the flowcharts and/or the block diagrams. These computer-readable program instructions may alternatively be stored in the computer-readable storage medium. These instructions enable a computer, a programmable data processing apparatus, and/or another device to work in a specific manner. Therefore, the computer-readable medium storing the instructions includes an artifact that includes instructions for implementing the various aspects of the functions/actions specified in one or more blocks in the flowcharts and/or block diagrams.

The computer-readable program instructions may be loaded onto a computer, another programmable data processing apparatus, or another device, such that a series of operation steps are performed on the computer, the another programmable data processing apparatus, or the another device to produce a computer-implemented process. Therefore, the instructions executed on the computer, the another programmable data processing apparatus, or the another device implement functions/actions specified in one or more blocks in the flowcharts and/or the block diagrams.

The flowcharts and the block diagrams in the accompanying drawings illustrate possible system architectures, functions, and operations of the system, the method, and the computer program product according to a plurality of implementations of the present disclosure. In this regard, each block in the flowcharts or the block diagrams may represent a part of a module, a program segment, or an instruction. The part of the module, the program segment, or the instruction includes one or more executable instructions for implementing a specified logical function. In some alternative implementations, functions marked in the blocks may occur in a sequence different from that marked in the accompanying drawings. For example, two consecutive blocks may actually be executed substantially in parallel, or may sometimes be executed in a reverse order, depending on a function involved. It should also be noted that each block in the block diagrams and/or the flowcharts, and a combination of the blocks in the block diagrams and/or the flowcharts may be implemented by a dedicated hardware-based system that executes specified functions or actions, or may be implemented by a combination of dedicated hardware and computer instructions.

The foregoing has described various implementations of the present disclosure. The foregoing descriptions are exemplary, not exhaustive, and are not limited to the disclosed implementations. Many modifications and variations are apparent to a person of ordinary skill in the art without departing from the scope and spirit of the described implementations. The selection of terms used herein is intended to best explain principles of the implementations, or improvements to technologies in the actual application, or to enable another person of ordinary skill in the art to understand the implementations disclosed herein.

I/We claim:

1. A method for generating an image collection, the method comprising:
displaying an image preview page in response to a trigger instruction associated with a first image collection, wherein the first image collection is associated with an image collection template, and at least part of text materials comprised in the image collection template is displayed in a specified region of the image preview page;
displaying at least one image in the specified region in response to acquiring the at least one image, wherein the at least part of the text materials are overlaid on a corresponding image of the at least one image; and
generating a second image collection based on the at least one image and the at least part of the text materials.

2. The method according to claim 1, wherein the first image collection comprises at least one reference image, reference text is displayed on a corresponding image of the at least one reference image, and the text material comprises the reference text.

3. The method according to claim 2, further comprising:
displaying a first display box of at least one display box in the specified region, wherein the at least one display box respectively corresponds to the at least one reference image; and
displaying first reference text in the first display box in response to the first reference text being displayed on a first reference image corresponding to the first display box, wherein a display position of the first reference text in the first display box is the same as a display position of the first reference text on the first reference image.

4. The method according to claim 3, further comprising:
at least partially displaying a second display box of the at least one display box in the specified region; and
displaying second reference text in the second display box in response to the second reference text being displayed on a second reference image corresponding to the second display box, wherein a display position of the second reference text in the second display box is the same as a display position of the second reference text on the second reference image.

5. The method according to claim 4, wherein the displaying the at least one image in the specified region comprises:
fully displaying the first display box in the specified region in response to the first display box being selected;
displaying, in the first display box, a first image to be processed of the at least one image determined by the user;
fully displaying the second display box in the specified region in response to the second display box being selected; and
displaying, in the second display box, a second image to be processed of the at least one image determined by the user.

6. The method according to claim 5, wherein the second display box is adjacent to the first display box in the specified region, and the method further comprises:
automatically selecting the second display box in response to the first image to be processed being displayed in the first display box.

7. The method according to claim 5, further comprising:
selecting the second display box in response to a select operation of the user.

8. The method according to claim 4, further comprising:
displaying, in the first display box, the masked first reference image; and
displaying, in the second display box, the masked second reference image.

9. The method according to claim 4, wherein a prompt control is comprised in a selected display box of the first display box and the second display box, and the method further comprises:
in response to triggering of the prompt control by the user, determining a reference image corresponding to the selected display box as a corresponding image to be processed, wherein before the prompt control is triggered, the corresponding reference image is displayed in the selected display box in a masked manner;
canceling masking of the corresponding reference image; and
displaying the corresponding reference image in the selected display box in a non-masked manner.

10. The method according to claim 9, further comprising:
in response to triggering of the prompt control by the user, sending, via a server, request information to a creator of the first image collection, to confirm that the corresponding reference image is allowed to be determined as the corresponding image to be processed; and
in response to receiving authorization information from the creator of the first image collection, determining the corresponding reference image as the corresponding image to be processed.

11. The method according to claim 1, further comprising:
displaying an edit page in response to the generation operation; and
displaying the at least one image on the edit page, wherein reference text is displayed on the corresponding image of the at least one image, and the reference text is the at least part of the text material.

12. The method according to claim 11, further comprising:
modifying the reference text in response to the user triggering a modify operation for the reference text.

13. The method according to claim 11, further comprising:
associating the template identifier with the second image collection in response to an operation of adding the template identifier to the second image collection, wherein the template identifier indicates that the second image collection is associated with the image collection template.

14. The method according to claim 1, wherein the first image collection comprises at least one reference image, and the text material is generated based on the at least one reference image.

15. The method according to claim 1, wherein the image collection template further comprises at least one of the following: an audio material, a sticker material, or a filter material.

16. A method for processing an image collection, the method comprising:
sending an image collection template associated with a first image collection to a user device in response to calling of the image collection template by the user device, wherein at least part of text materials comprised in the image collection template is displayed in a specified region of an image preview page of the user device;
receiving a second image collection generated with the image collection template, wherein the second image collection is generated by overlaying the at least part of the text materials on a corresponding image of at least one image; and
posting the second image collection, wherein the second image collection comprises the at least part of the text material.

17. The method according to claim 16, further comprising:
receiving the first image collection;
extracting information of reference text comprised in the first image collection in response to the first image collection meeting a preset condition; and
generating the image collection template based on the extracted information, wherein the text material comprised in the image collection template corresponds to the reference text.

18. The method according to claim 17, wherein the preset condition comprises at least one of the following: an option for generating an image collection template being selected when the first image collection is created; an evaluation parameter for the first image collection being greater than a first threshold; content of the first image collection being associated with target content; or an attribute of the first image collection matching a preset attribute;
the image collection template further comprises at least one of the following: an audio material, a sticker material, or a filter material;
the text material has associated information, and wherein the at least part of the text material is displayed in the specified region of the image preview page based on the information; and
the first image collection comprises at least one reference image, and the text material is generated based on the at least one reference image.

19. The method according to claim 17, further comprising:
adding a template identifier to the first image collection in response to the first image collection meeting the preset condition, wherein the template identifier corresponds to the image collection template;
obtaining the image collection template associated with the first image collection based on a template identifier associated with the first image collection; and
adding a template identifier to the second image collection, wherein the template identifier corresponds to the image collection template.

20. An electronic device, comprising:
at least one processing unit; and
at least one memory coupled to the at least one processing unit and storing instructions executable by the at least one processing unit, wherein the instructions, when executed by the at least one processing unit, cause the electronic device to:
display an image preview page in response to a trigger instruction associated with a first image collection, wherein the first image collection is associated with an image collection template, and at least part of text materials comprised in the image collection template is displayed in a specified region of the image preview page;
display at least one image in the specified region in response to acquiring the at least one image, wherein the at least part of the text materials are overlaid on a corresponding image of the at least one image; and
generate a second image collection based on the at least one image and the at least part of the text materials.
